(19) United States
(12) Patent Application Publication
(10) Pub. No.: US 2012/0060763 A1
(43) Pub. Date: Mar. 15, 2012

(54) ADHESIVE OPTICAL FIBER DEVICE FOR AN AQUARIUM

(76) Inventor: Chuan-Hsiang LIN, New Taipei City (TW)

(21) Appl. No.: 13/160,727

(22) Filed: Jun. 15, 2011

(30) Foreign Application Priority Data
Sep. 13, 2010 (CN) 201020525642.0.

(51) Int. Cl. A01K 63/06

(52) U.S. Cl. 119/267

(57) ABSTRACT

An adhesive optical fiber device for aquarium has a light-emitting device and a light-guiding optical fiber device. The light-emitting device and the light-guiding optical fiber device include respectively a first magnetic device and a second magnetic device. The light-emitting device and the light-guiding optical fiber device are disposed on the outer and inner surfaces of a sidewall of the aquarium, respectively, and fixed thereon due to the attraction between the first magnetic device and the second magnetic device. The light source of the light-emitting device aims at a light entrance of the light-guiding optical fiber device, so that the optical fiber cores of the light-guiding optical fiber device can transmit light and emit light on their free ends. The optical fiber cores in the aquarium can be distributed by demand to decorate the aquarium.

### BACKGROUND OF THE INVENTION

1. Field of the Invention

The invention relates to a light-emitting ornament for an aquarium and, in particular, to an adhesive optical fiber device for an aquarium.

2. Description of Related Art

Most aquaria are decorated with ornaments to beautify the aquaria, in addition to the purpose of increasing hiding places for fish. Currently, there are various kinds of ornaments on the market.

However, these ornaments cannot emit light automatically for special effects. Therefore, the sidewalls of the aquarium are often attached with an external light source. As a user turns on the light source, the ornaments in water light up as well. Since the light source usually emits light downward, it cannot provide uniform illumination as natural light does during the daytime. To achieve the same effect, the user has to add more light sources or use a fixed lamp. This occupies more space in the aquarium, and is very inconvenient for cleaning. It is thus desirable to provide a better illumination device for the aquaria.

### SUMMARY OF THE INVENTION

An adhesive optical fiber device for an aquarium in accordance with the present invention can be easily mounted to or detached from the aquarium, and provides illumination in different directions. Moreover, it does not cause any problem for aquarium cleaning.

The adhesive optical fiber device for an aquarium has a light-emitting device and a light-guiding optical fiber device. The light-emitting device and the light-guiding optical fiber device include respectively a first magnetic device and a second magnetic device. The light-emitting device and the light-guiding optical fiber device are disposed on the outer and inner surfaces of a sidewall of the aquarium, respectively, and fixed thereon due to the attraction between the first magnetic device and the second magnetic device. The light source of the light-emitting device aims at a light entrance of the light-guiding optical fiber device, so that the optical fiber cores of the light-guiding optical fiber device can transmit light and emit light on their free ends. The optical fiber cores in the aquarium can be distributed by demand to decorate the aquarium and to light up landscape in the aquarium.

To clean the aquarium, the user only needs to separate the light-emitting device from the light-guiding optical fiber device so that they are no longer attracted to each other. The user can then take the light-guiding optical fiber device out of water directly, making the mounting and detaching job much easier and faster.

### BRIEF DESCRIPTION OF THE DRAWINGS

FIG. 1 is a perspective view of a first embodiment of an adhesive optical fiber device in accordance with the present invention;

FIG. 2 is another perspective view of the first embodiment of the invention;

FIG. 3 is yet another perspective view of the first embodiment of the invention;

FIG. 4 is an exploded view of a first embodiment of a light-emitting device of the adhesive optical fiber device;

FIG. 5 is an exploded view of a first embodiment of a light-guiding optical fiber device of the adhesive optical fiber device;

FIG. 6 is an exploded view of a second embodiment of a light-guiding optical fiber device of the adhesive optical fiber device;

FIG. 7 is a cross-sectional view of the adhesive optical fiber device mounted in an aquarium;

FIG. 8 is a first operational view of the adhesive optical fiber device in an aquarium; and

FIG. 9 is a second operational view of the adhesive optical fiber device mounted in another aquarium.

### DETAILED DESCRIPTION OF THE PREFERRED EMBODIMENT

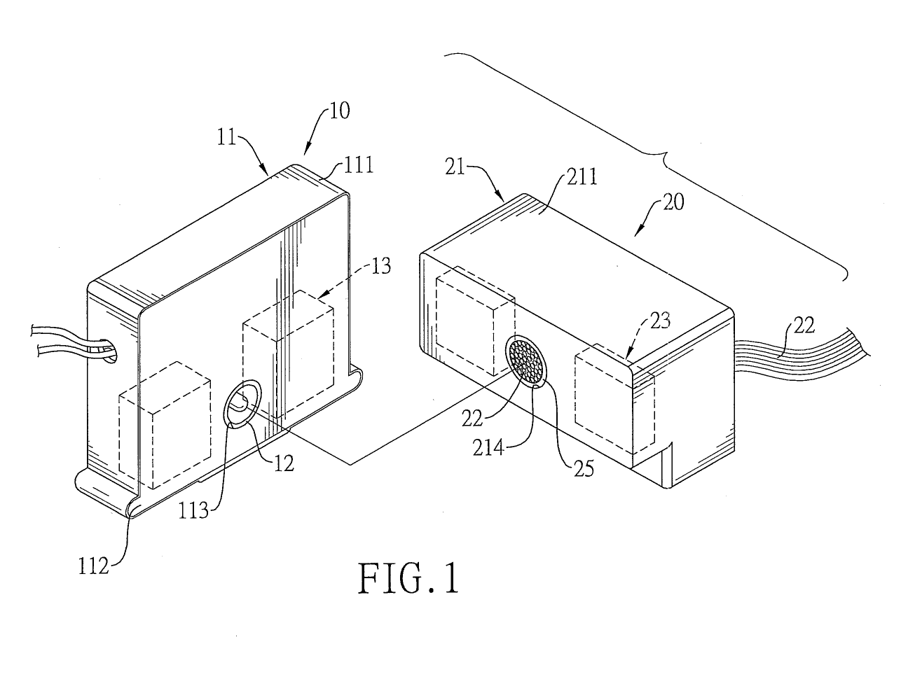

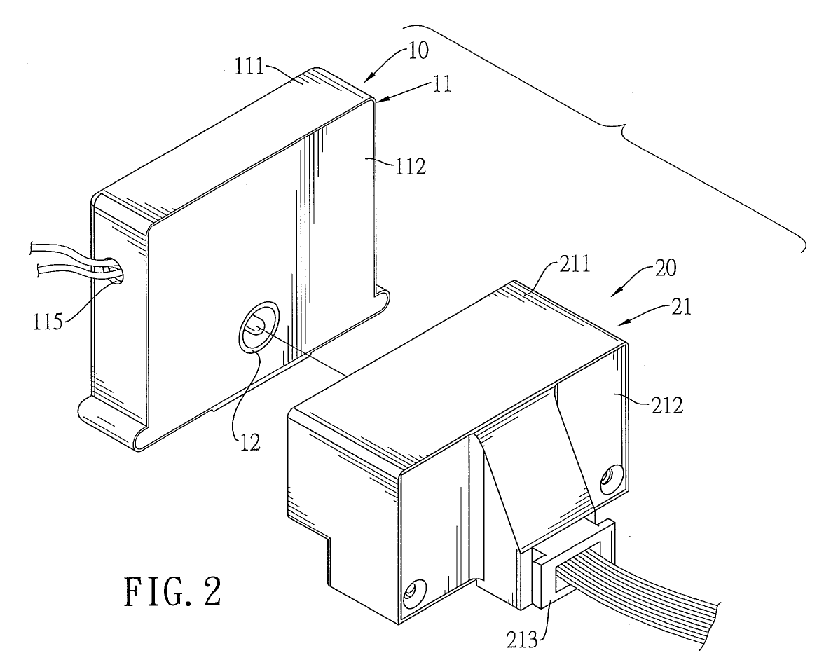

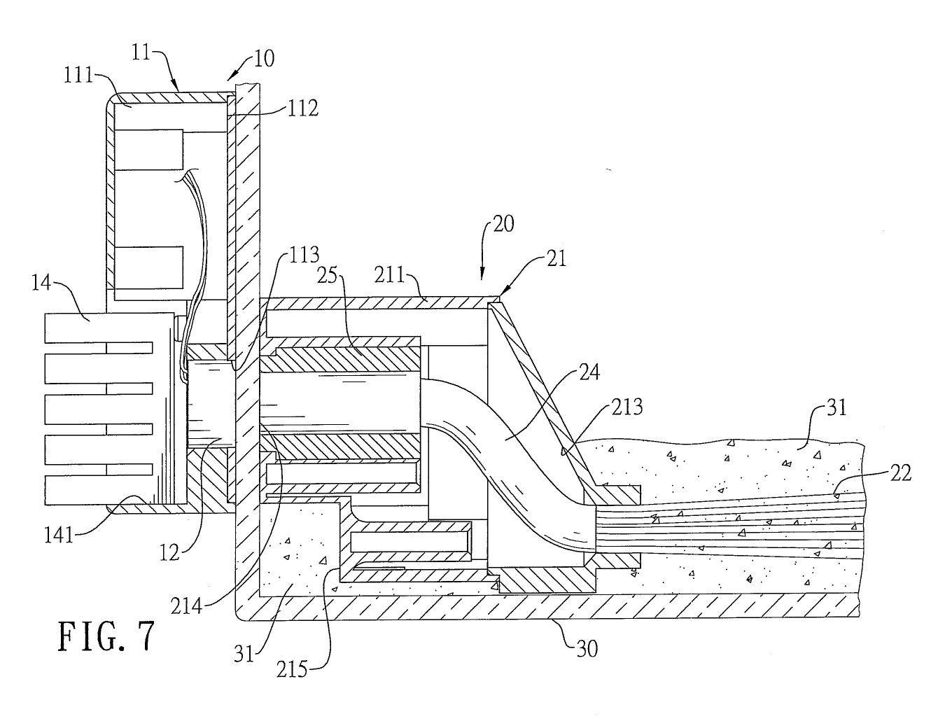

With reference to FIGS. 1, 2, and 7, a first preferred embodiment of an adhesive optical fiber device for an aquarium comprises a light-emitting device 10 and a light-guiding optical fiber device 20.

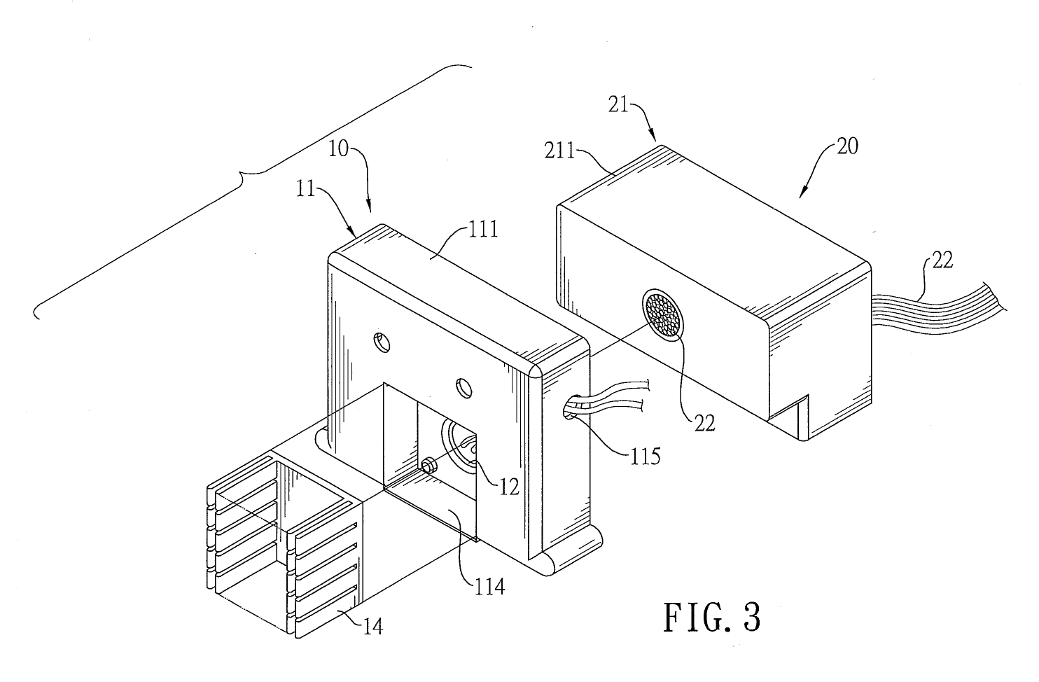

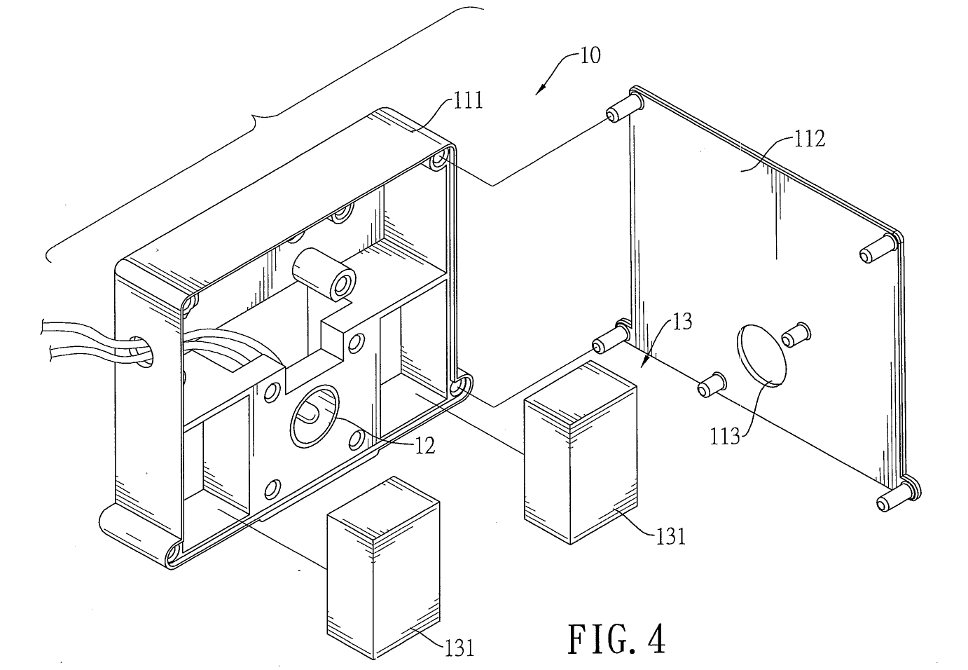

The light-emitting device 10 comprises a housing 11, a light source 12 and a first magnetic device 13 both mounted in the housing 11. With reference to FIGS. 3 and 4, the housing 11 includes a shell 111 and a front cover 112. The shell 111 accommodates the light source 12 and has a side. A through hole 115 is formed in the side of the shell 111 for power lines of the light source 12 to extend out. The front cover 112 covers the shell 111 and has an opening 113 at a position corresponding to the light source 12 in the shell 111, so that the light emitted by the light source 12 radiates out via the opening 113. A rear side of the shell 111 is further formed with an accommodating room 114 corresponding to the light source 12 to accommodate a heat sink 14 that is attached to a rear end of the light source 12. The heat generated by the light source 12 is thus dissipated outside the housing 11, ensuring the normal functioning of the light source 12. In this embodiment, the first magnetic device 13 includes two magnetic sheets 131, which can be an iron sheet or simply magnet. The two magnetic sheets 131 are held in the shell 111 and near both opposite sides of the light source 12. The light-guiding optical fiber device 20 comprises a box 21, a plurality of optical fiber cores 22 and a second magnetic device 23 both mounted in the box 21. A common end of the optical fiber cores 22 is fixed at a light entrance 214 formed on an outer side of the box 21. The rest portion of each optical fiber core 22 is exposed outside the box 21. The other ends of the optical fiber cores 22 can be distributed to arbitrary positions in the aquarium by demand. The second magnetic device 23 is attracted to the first magnetic device 13.

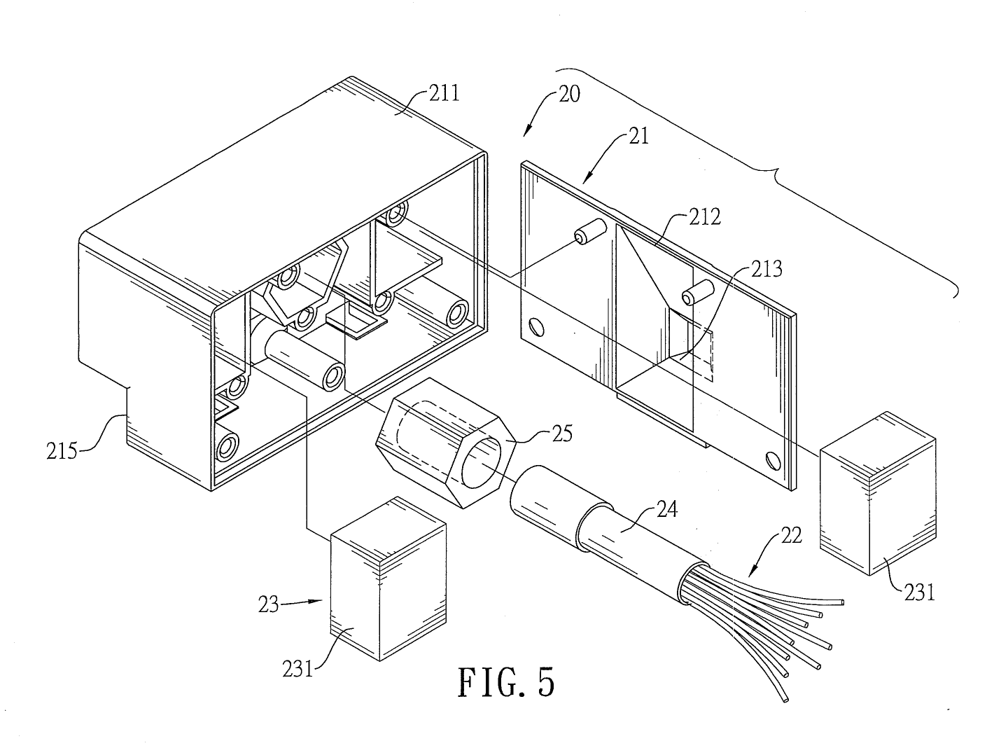

With reference to FIG. 5, the box 21 includes a box body 211 and a back cover 212. The back cover 212 covers a rear opening of the box body 211 and forms a shrinking passage 213 backwards. The light entrance 214 is formed on the front side of the box body 211. The common end of the optical fiber cores 22 is inserted into a bundle 24, and then into a positioning post 25. The positioning post 25 is held in the light entrance 214. In this embodiment, the second magnetic device 23 includes two magnetic sheets 231, being magnets or iron sheets, held in the box body 211 and near both opposite sides of the light entrance 214 respectively.

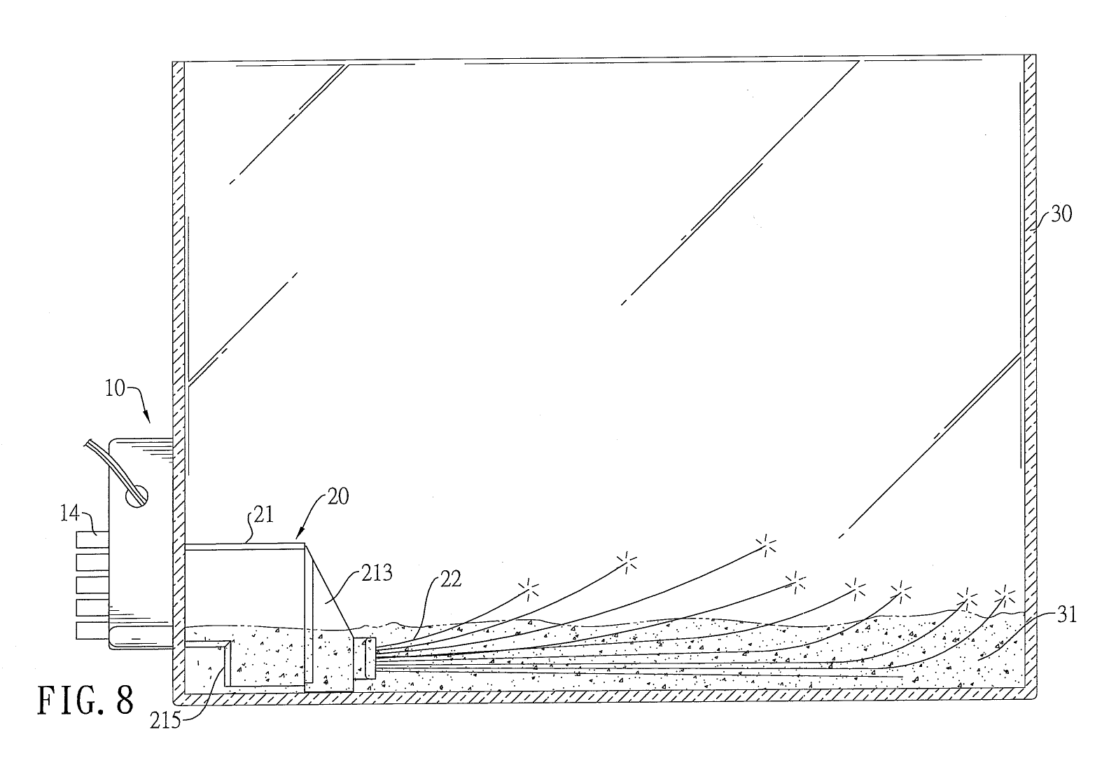

The front side of the box body 211 of the box 21 of the light-guiding optical fiber device 20 is recessed with a long notch 215 near a bottom surface thereof, rendering an inverted-L shape for the box body 211. With reference to FIG. 8, when the user installs the invention to an aquarium 30, the light-emitting device 10 and the light-guiding optical fiber device 20 are disposed on an outer surface and an inner surface of a sidewall of the aquarium 30, respectively. The first and second magnetic devices 13, 23 magnetically attract each other and are positioned on the outer and inner surfaces of the sidewall of the aquarium. Moreover, the light source 12 of the light-emitting device 10 aims at the light entrance 214 of the light-guiding optical fiber device 20, so that the optical fiber cores 22 transmit the light to light up the other end. Since the bottom surface of the aquarium 30 is usually paved with fine sands 31, the inverted-L design of the box body 211 enables the bottom surface of the box 21 of the light-guiding optical fiber device 20 to be embedded with the sands 31. This reinforces the positioning of the light-guiding optical fiber device 20 in the aquarium 30.

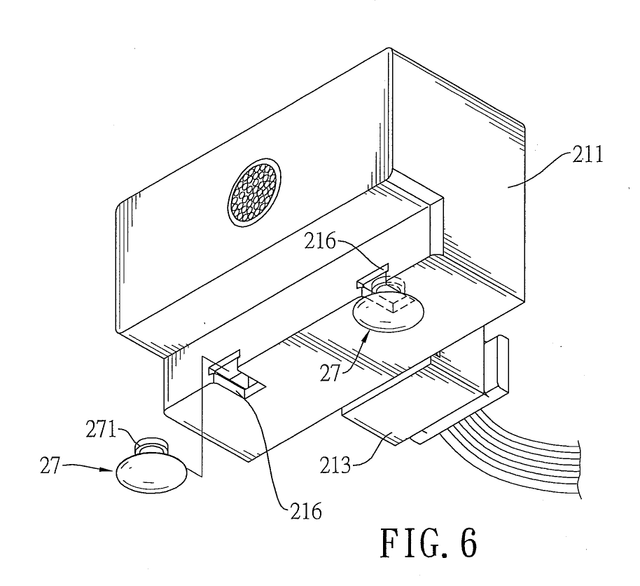

With reference to FIG. 6, a second embodiment of the light-guiding optical fiber device 20 is mostly the same as the first embodiment, except that the bottom surface of the box body 211 is formed with at least one engaging groove 216 and has at least one sucker 27. A T-shaped support 271 of each of the suckers 27 engages with the corresponding engaging groove 216. In this embodiment, the box body 211 is formed with two engaging grooves 216 for two suckers 27 to engage. Therefore, the light-guiding optical fiber device 20 can directly hold on to the bottom surface or a water-filtering board on the bottom surface of the aquarium 30 via the suckers 27. The light-guiding optical fiber device 20 is therefore firmly fixed in the aquarium 30.

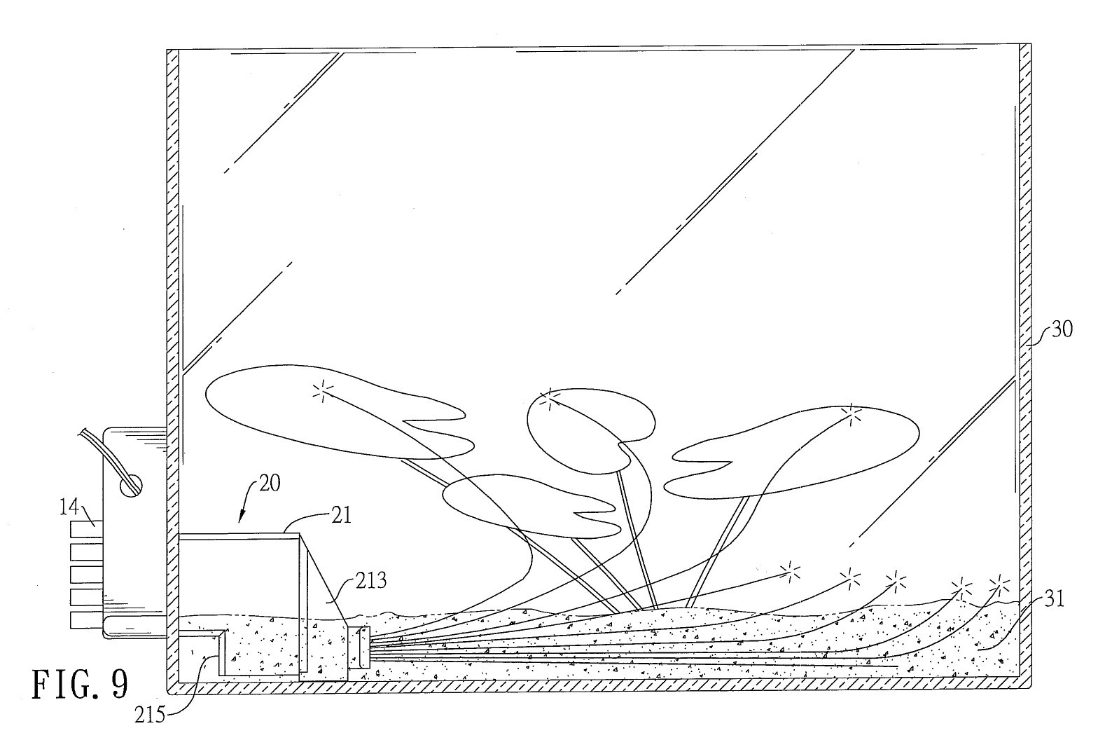

With reference to FIG. 9, the invention is installed in an aquarium with an ornamental landscape. Since the exposed optical fiber cores 22 of the light-guiding optical fiber device 20 are soft, the user can pull them to various parts of the landscape. The free ends of the optical fiber cores 22 emit light to light up the landscape. Since light can be guided to the landscape in the aquarium 30 or different places in the aquarium 30, the invention can provide more uniformly distributed light than conventional fixed single light source. The user can enjoy viewing the landscape and fish even in the dark night. To clean the aquarium, the user only needs to separate the light-emitting device 10 from the light-guiding optical fiber device 20 so that they are no longer attracted to each other. Then the user can readily take the light-guiding optical fiber device 20 out of water. The mounting and detaching job is fairly easy and fast.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adhesive optical fiber device for an aquarium comprising:
a light-emitting device having
a housing;
a light source mounted in the housing; and
a first magnetic device mounted in the housing; and
a light-guiding optical fiber device having
a box having an outer side and a light entrance formed on the outer side;
a plurality of optical fiber cores, wherein one common end of the plurality of the optical fiber cores is fixed in the light entrance of the box, and the rest is exposed outside the box; and
a second magnetic device mounted in the box and being attractive to the first magnetic device.

2. The adhesive optical fiber device as claimed in claim 1, wherein the housing comprises:
a shell accommodating the light source and having a through hole formed through the shell to allow power lines of the light source to extend outward; and
a front cover covering the shell and formed with an opening corresponding to the light source in the shell in order for the light from the light source to go out.

3. The adhesive optical fiber device as claimed in claim 2, wherein the shell further has
a rear side; and
an accommodating room formed in the rear side of the shell, corresponding to the light source, and accommodating a heat sink.

4. The adhesive optical fiber device as claimed in claim 1, wherein the first magnetic device includes two magnetic sheets mounted near opposite sides of the light source.

5. The adhesive optical fiber device as claimed in claim 1, wherein the box comprises:
a box body having a back opening and a front side, wherein the light entrance is formed through the front side; and
a back cover covering the back opening of the box and forming a shrinking passage.

6. The adhesive optical fiber device as claimed in claim 2, wherein the box comprises:
a box body having a back opening and a front side, wherein the light entrance is formed through the front side; and
a back cover covering the back opening of the box and forming a shrinking passage.

7. The adhesive optical fiber device as claimed in claim 3, wherein the box comprises:
a box body having a back opening and a front side, wherein the light entrance is formed through the front side; and
a back cover covering the back opening of the box and forming a shrinking passage.

8. The adhesive optical fiber device as claimed in claim 7, wherein the common end of the optical fiber cores is inserted into a bundle and then into a positioning post, and the positioning post is mounted in the light entrance.

9. The adhesive optical fiber device as claimed in claim 7, wherein the front side of the box body is recessed with a long notch near a bottom surface of the box body.

10. The adhesive optical fiber device as claimed in claim 9, wherein the bottom surface of the box body is formed with at least one engaging groove and has at least one sucker with a T-shaped support engaged in the corresponding engaging groove.

11. The adhesive optical fiber device as claimed in claim 10, wherein the second magnetic device includes two magnetic sheets disposed in the box near opposite sides of the light entrance.
